(19) United States
(12) Patent Application Publication
(10) Pub. No.: US 2007/0085939 A1
(43) Pub. Date: Apr. 19, 2007

(54) Thin film transistor substrate with improved inter-layer adhesion

(75) Inventor: Chun Gi You, Hwaseong-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/399,766

(22) Filed: Apr. 7, 2006

(30) Foreign Application Priority Data
Oct. 18, 2005 (KR) 10-2005-0097923

(51) Int. Cl. G02F 1/136

(52) U.S. Cl. 349/43

(57) ABSTRACT

Disclosed are a thin film transistor (TFT) substrate capable of preventing separation between an organic layer and an inorganic layer, a method of fabricating the TFT substrate, an LCD panel having the TFT substrate, and a method of fabricating the LCD panel. The TFT thin film transistor substrate includes a TFT connected to a gate line and a data line, an organic protective layer for protecting the thin film transistor, and an inorganic insulating layer formed between the gate line and the data line. The inorganic insulating layer is formed such that a contact surface with the organic protective layer has a different pattern from a non-contact surface with the organic protective layer.

### CROSS-REFERENCE TO RELATED APPLICATION

This patent application claims priority from Korean Patent Application No. 10-2005-0097923 filed on Oct. 18, 2005, the content of which is incorporated by reference herein in its entirety.

### BACKGROUND OF THE INVENTION

1. Field of the Invention

The present invention relates to a thin film transistor (“TFT”) substrate and a liquid crystal display (“LCD”) panel having the same, and more particularly, to a TFT substrate capable of preventing separation between an organic layer and an inorganic layer, a method of fabricating the TFT substrate, an LCD panel having the TFT substrate, and a method of fabricating the LCD panel.

2. Description of the Related Art

An LCD apparatus typically displays an image by controlling light transmittance through liquid crystal cells in response to a video signal. The liquid crystal cells are arranged in a matrix format on an LCD panel.

The LCD apparatus includes, as illustrated in FIG. 1, a TFT substrate 40 and a color filter substrate 42 which are sealed by a sealant 48. A liquid crystal layer is disposed between the TFT substrate 40 and the color filter substrate 42.

The color filter substrate 42 includes a black matrix for preventing light leakage, a color filter for forming colors, a common electrode for forming a vertical electric field with respect to a pixel electrode, and an upper alignment layer deposited to align the liquid crystal.

The TFT substrate 40 includes gate lines and data lines configured to extend perpendicularly to each other on a lower substrate 1, TFTs formed at the intersections of the gate lines and data lines, pixel electrodes connected to the TFTs, and a lower alignment layer deposited for the alignment of liquid crystal materials.

The TFTs are protected by an inorganic protective layer 26 and an organic protective layer 18. The organic protective layer 18 is formed on the inorganic protective layer 26 in order to increase an aperture ratio. A parasitic capacitor is formed by the pixel electrode and the signal line sandwiching the organic protective layer 18 of a low dielectric constant. The capacitance of this parasitic capacitor is minimal compared to that of a capacitor formed with the inorganic protective layer of a high dielectric constant. The pixel electrode and the signal line can be overlapped by the organic protective layer 18, in which case the aperture ratio is increased.

A problem with the configuration of FIG. 1 is that the bonding force between the inorganic protective layer 26 and the organic protective layer 18 is weak. As a result of this weak bonding force, the inorganic protective layer 26 and organic protective layer 18 occasionally separate from each other, especially near the area overlapped by a sealant.

To solve such a problem, a method has been proposed whereby the organic protective layer is selectively removed from an area covered by the sealant. However, when a driving circuit is formed using the TFTs on the lower substrate, the driving circuit covered by the sealant is occasionally eroded during a patterning process of a transparent conductive layer. Further, if the sealant is deposited on an area where the organic protective layer is removed, the inorganic protective layer cannot withstand the pressure applied onto the TFT substrate through the sealant, and thus the driving circuit becomes damaged.

### SUMMARY OF THE INVENTION

The present invention provides a TFT substrate capable of preventing separation between an organic layer and an inorganic layer, a method of fabricating the TFT substrate, an LCD panel having the TFT substrate, and a method of fabricating the LCD panel.

In one aspect, the invention is a TFT substrate including a TFT connected to a gate line and a data line, an organic protective layer for protecting the TFT, and an inorganic insulating layer formed between the gate line and the data line. The inorganic insulating layer is formed such that its contact surface with the organic protective layer has a different pattern from the rest of its surface.

The TFT substrate may also include an inorganic protective layer which is formed on the data line and source and drain electrodes of the TFT and is patterned to have the same shape as the data line and the source and drain electrodes of the TFT when viewed from the top.

The inorganic insulating layer may be formed such that the contact surface with the organic protective layer has a concavo-convex pattern and the rest of its surface has a flat pattern.

In another aspect, the present invention is a color filter substrate by a sealant that includes a TFT formed on a substrate and connected to a gate line and a data line, an organic protective layer for protecting the TFT, and an inorganic insulating layer formed between the gate line and the data line. The inorganic insulating layer is formed such that a contact surface with the organic protective layer in a region overlapping the sealant has a concavo-convex pattern.

The height of at least one of the bumps in the concavo-convex pattern of the inorganic insulating layer is about 100 to 1000 Å.

The TFT may include an active layer formed on the substrate, a gate electrode connected to the gate line on a gate insulating layer configured to cover the active layer, a source electrode connected to the data line on an interlayer insulating layer configured to cover the gate electrode, and a drain electrode formed on the interlayer insulating layer, the drain electrode positioned across the active layer from the source electrode.

The inorganic insulating layer may be the interlayer insulating layer formed such that its contact surface with the data line, source electrode and drain electrode is different from its contact surface with the organic protective layer.

The interlayer insulating layer may have a flat contact surface with the data line, source electrode and drain electrode.

The TFT substrate may also include an inorganic protective layer which is formed on the source electrode, drain electrode and data line and has the same shape as the source electrode, drain electrode and data line when viewed from the top.

The TFT may include a gate electrode formed on the substrate, an amorphous silicon active layer formed on a gate insulating layer configured to cover the gate electrode, an ohmic contact layer configured to expose a channel region of the active layer, and source and drain electrodes positioned across the channel region from each other.

The inorganic insulating layer may be the gate insulating layer formed such that a contact surface with at least one of the active layer, ohmic contact layer, source electrode and drain electrode is different from its contact surface with the organic protective layer.

The gate insulating layer may have a flat contact surface with the data line, source electrode and drain electrode.

The TFT substrate may also include an inorganic protective layer which is formed on the source electrode, drain electrode and data line and has the same shape as the source electrode, drain electrode and data line in plan view.

In yet another aspect, the present invention is a method of fabricating a TFT substrate. The method entails forming a first conductive pattern group including a gate electrode and a gate line on a substrate, forming an inorganic insulating layer to cover the first conductive pattern group, forming a second conductive pattern group including a data line, a source electrode and a drain electrode on the inorganic insulating layer and processing a surface of the inorganic insulating layer to have a contact surface with the second conductive pattern group different from a rest of its surface, forming an organic protective layer to cover the second conductive pattern group, and forming a third conductive pattern group including a pixel electrode on the organic protective layer.

The forming of a second conductive pattern group and the processing of a surface of the inorganic insulating layer may include forming an inorganic protective layer patterned to have the same shape as the second conductive pattern group on the second conductive pattern group.

The forming of a second conductive pattern group and the processing of a surface of the inorganic insulating layer may include sequentially depositing a data metal layer and the inorganic protective layer on the inorganic insulating layer, forming a photoresist pattern on the inorganic protective layer, primary-etching a part of the inorganic protective layer and the data metal layer by using the photoresist pattern, and secondary-etching the data metal layer by using the photoresist pattern to form the second conductive pattern group and processing the surface of the inorganic insulating layer by using an etching gas used for the secondary etching.

The etching gas used for the secondary etching may be Cl₂, O₂, or Cl₂+O₂.

In yet another aspect, the present invention is an LCD panel that includes a TFT substrate including an inorganic insulating layer having a patterned contact surface and a flat surface, the patterned contact surface having a concavo-convex pattern that protects a thin film transistor. The LCD panel also includes a color filter substrate positioned substantially parallel to the TFT substrate and the color filter substrate, and a sealant formed on a region overlapping the patterned contact surface. for the sealant seals the TFT substrate and the color filter substrate.

In yet another aspect, the present invention is a method of fabricating an LCD panel. The method entails preparing a color filter substrate, preparing a TFT substrate including an inorganic insulating having a patterned contact surface and a flat surface. The patterned contact surface has a concavo-convex pattern for interfacing with an organic protective layer that protects a thin film transistor. The method also entails sealing the color filter substrate and the TFT substrate by using a sealant formed on a region overlapping the inorganic insulating layer having the concavo-convex pattern.

### BRIEF DESCRIPTION OF THE DRAWINGS

The above and other objects, features and advantages of the present invention will become more apparent from the following detailed description when taken in conjunction with the accompanying drawings in which:

FIG. 1 is a cross-sectional view of a conventional LCD panel;

FIG. 2 is a plane view of an LCD panel according to an exemplary embodiment of the present invention;

FIG. 3 is a cross-sectional view taken along line I-I′ and II-II′ in FIG. 2;

FIG. 4 is an enlarged view of a region A shown in FIG. 3;

FIGS. 5A to 5G are cross-sectional views for explaining a process of fabricating an LCD panel according to an exemplary embodiment of the present invention;

FIGS. 6A to 6C are cross-sectional view for explaining a process of fabricating the second conductive pattern group and the inorganic protective layer shown in FIG. 5D;

FIG. 7 is a cross-sectional view of an LCD panel according to another exemplary embodiment of the present invention; and

FIG. 8 is a view illustrating an adhering force between layers of an LCD panel according to the prior art and the present invention.

### DETAILED DESCRIPTION OF THE INVENTION

The exemplary embodiments of the present invention will be described herein below with reference to the attached drawings. The invention may, however, be embodied in many different forms and should not be construed as limited to the embodiments set forth herein. Like numerals refer to like elements throughout the drawings.

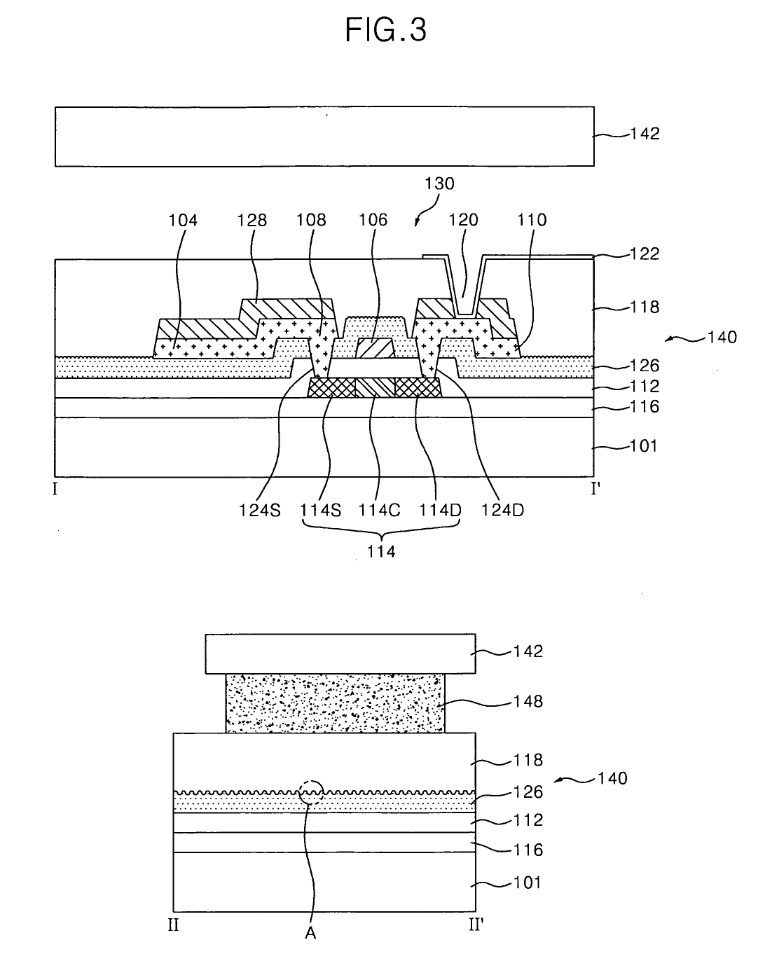

FIG. 2 is a plan view of an LCD panel according to an exemplary embodiment of the present invention, and FIG. 3 is a cross-sectional view taken along line I-I′ and II-II′ in FIG. 2.

Referring to FIGS. 2 and 3, the LCD panel includes a TFT substrate 140, a color filter substrate 142, and a sealant 148 for assembling the TFT substrate 140 and the color filter substrate 142.

The color filter substrate 142 is configured such that a color filter array including a black matrix for preventing light leakage, a color filter for forming colors, and a common electrode forming a vertical electric field with respect to a pixel electrode 122 is formed on an upper substrate.

The TFT substrate 140 includes a TFT 130 connected to a gate line 102 and a data line 104, an inorganic protective layer 128 and organic protective layer 118 for protecting the TFT 130, and the pixel electrode 122 connected to the TFT 130. The TFT 130 may be either an N type or P type. In the present exemplary embodiment, an N type TFT is used, as will be explained.

The gate line 102 is connected to a gate driver (not shown) via a gate pad 150. The data line 104 is connected to a data driver (not shown) via a data pad 160.

The TFT 130 charges a video signal to the pixel electrode 122. The TFT 130 includes a gate electrode 106 connected to the gate line 102, a source electrode 108 connected to the data line 104, a drain electrode 110 connected to the pixel electrode 122 through a pixel contact hole 120 penetrating the inorganic protective layer 128 and organic protective layer 118, and an active layer 114 forming a channel between the source electrode 108 and drain electrode 110 by the gate electrode 106.

The active layer 114 is formed on a lower substrate 101 with a buffer layer 116 disposed between the active layer 114 and the lower substrate 101. The gate electrode 106 connected to the gate line 102 is superposed on a channel region 114C of the active layer 114, with a gate insulating layer 112 formed therebetween.

The source electrode 108 is insulated from the drain electrode 110 by the gate electrode 106 and an interlayer insulating layer 126 disposed therebetween.

The source electrode 108 connected to the data line 104 and the drain electrode 110 are respectively connected to a source region 114S and a drain region 114D of the active layer 114. n+ impurities are injected through a source contact hole 124S and a drain contact hole 124D that extend through the interlayer insulating layer 126 and the gate insulating layer 112. In order to reduce the OFF current, the active layer 114 may further include a lightly doped drain (“LDD”) region into which n− impurities are injected between the source and drain regions 114S and 114D.

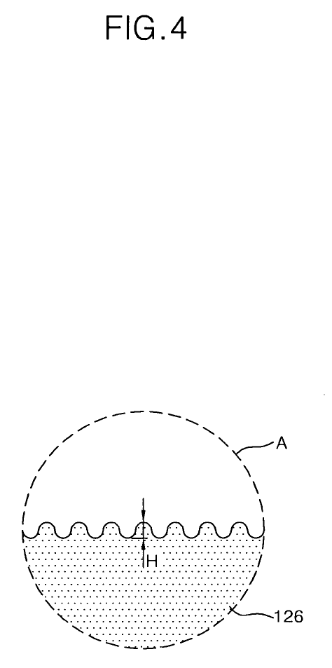

The inorganic protective layer 128 having essentially the same pattern as the source electrode 108, drain electrode 110 and data line 104 is formed on the source electrode 108, drain electrode 110, and the data line 104. The interlayer insulating layer 126 at a region covered by the inorganic protective layer 128 is formed to have a planarized surface. The interlayer insulating layer 126 at a region which is not covered by the inorganic protective layer 128 (e.g., the region covering the channel region 114C) is formed to have a bumpy or uneven concave-convex surface. As illustrated in FIG. 4, the height H of at least one of the bumps in the concavo-convex pattern is about 100 to about 1000 Å. The interlayer insulating layer 126 is made of an inorganic insulating material such as SiNx or SiO₂, which is the same material as that used for the inorganic protective layer 128.

In order to increase the aperture ratio, the organic protective layer 118 is formed on the lower substrate 101 on which the inorganic protective layer 128 is formed. The organic protective layer 118 is in contact with the concave-convex patterned region of the interlayer insulating layer 126. The concavo-convex pattern of the interlayer insulating layer 108 increases the bonding force between the organic protective layer 118 and the interlayer insulating layer 126. The concave-convex pattern formed in the region where the sealant 148 will be disposed reduces the likelihood that the organic protective layer 118 and the interlayer insulating layer 126 will separate in the sealant region.

As described above, the LCD panel of the exemplary embodiment of the present invention prevents separation of the organic protective layer 118 from the interlayer insulating layer 126 at a region where the sealant 148 is disposed by forming the concavo-convex pattern on the interlayer insulating layer 126. As mentioned above, the pattern enhances the bonding between the interlayer insulating layer 126 and the organic protective layer 118.

Moreover, erosion of a driving circuit during the patterning process of a transparent conductive layer is prevented because the driving circuit formed on the lower substrate 101 is protected by the organic protective layer 118.

Furthermore, damage to the driving circuit is prevented because the organic protective layer 118 can endure the pressure applied onto the TFT 130 through the sealant 148.

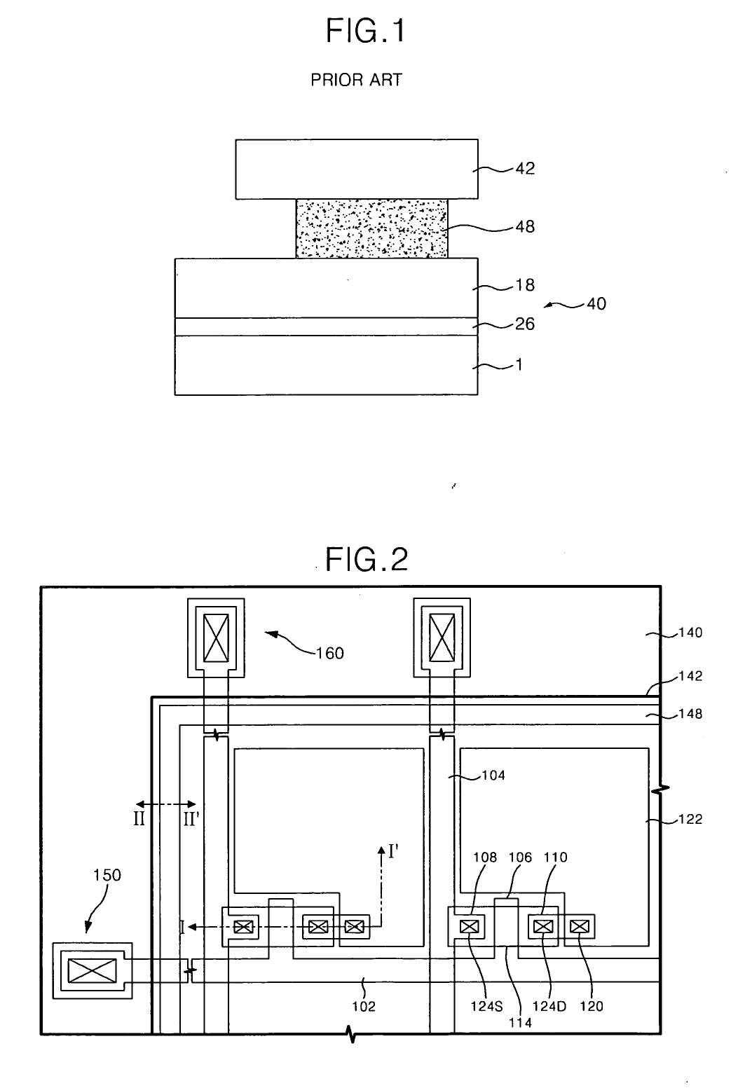

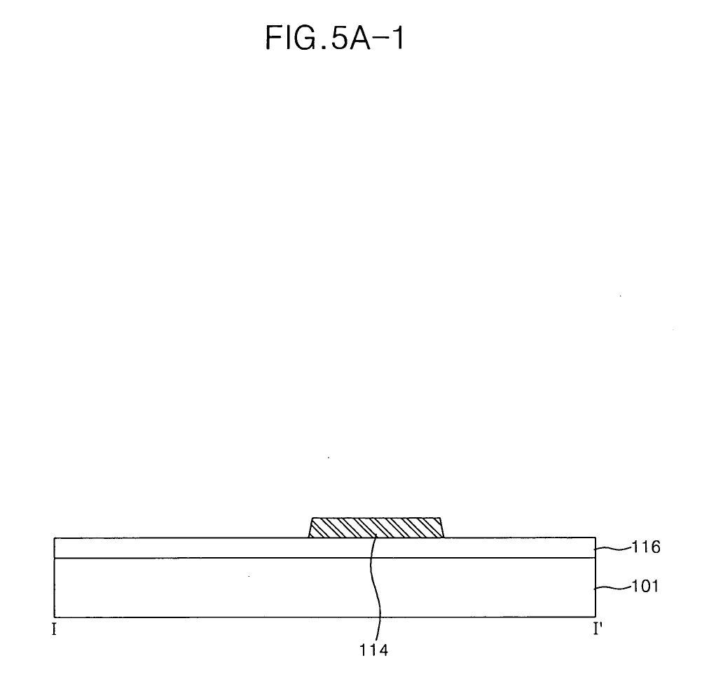

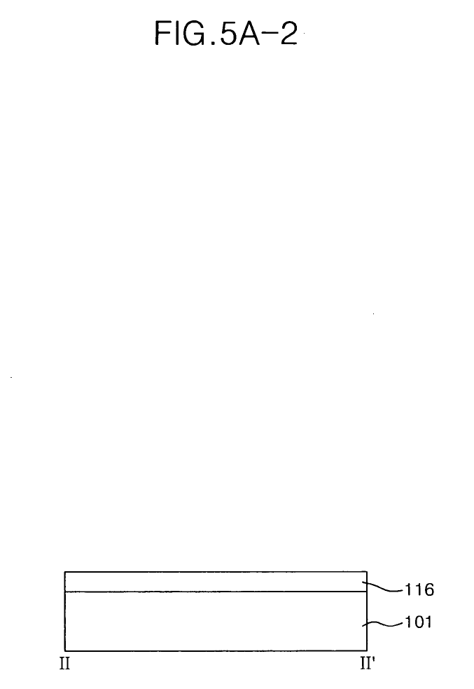

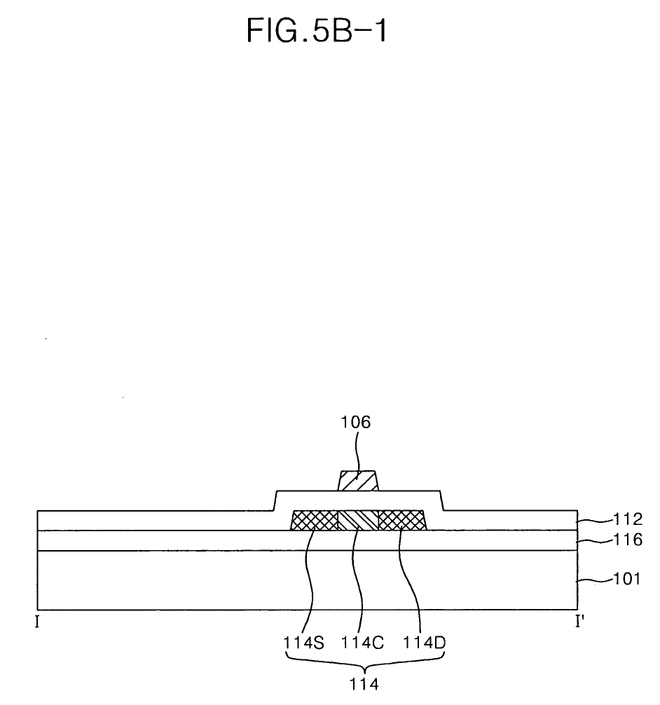

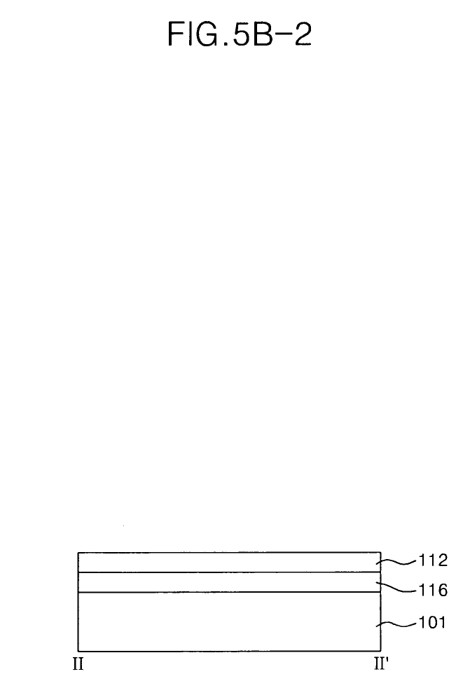

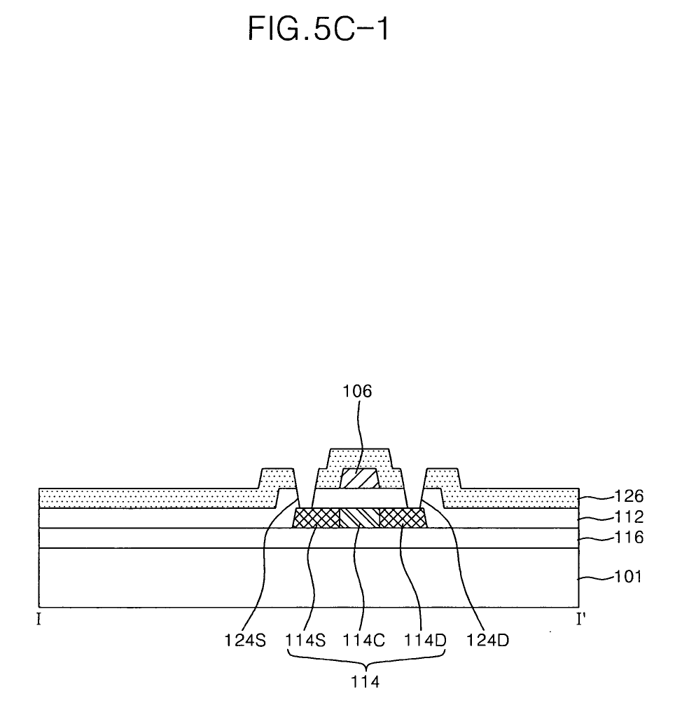

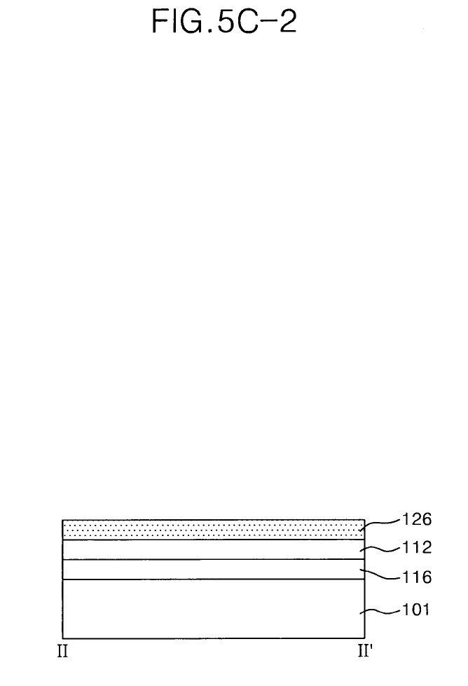

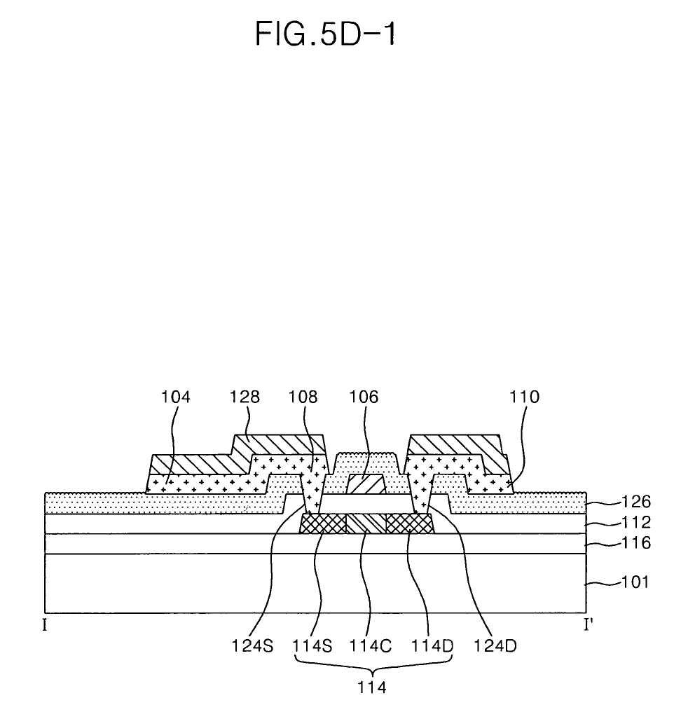

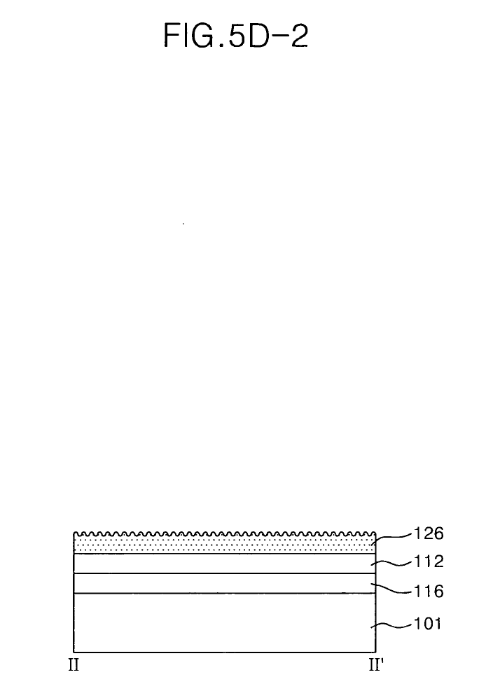

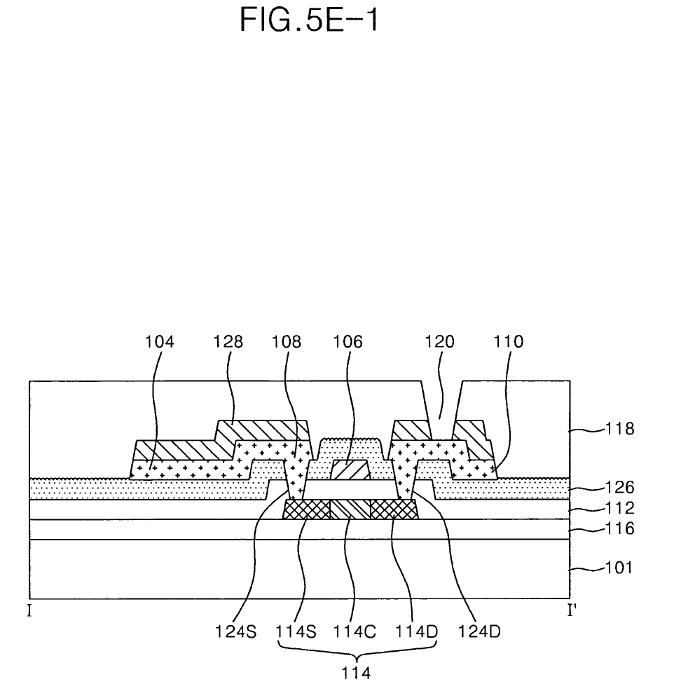

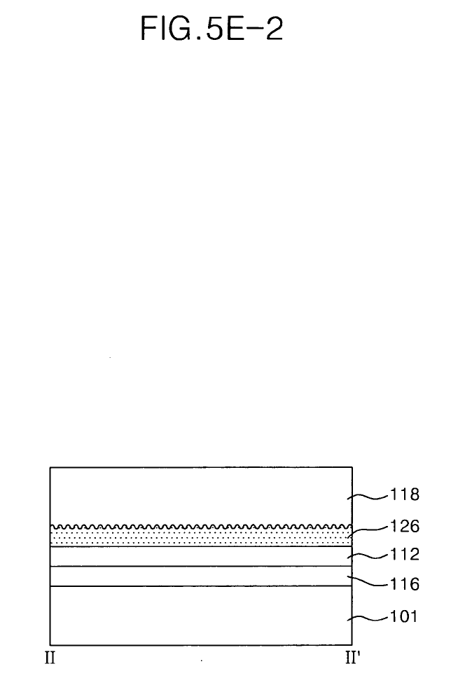

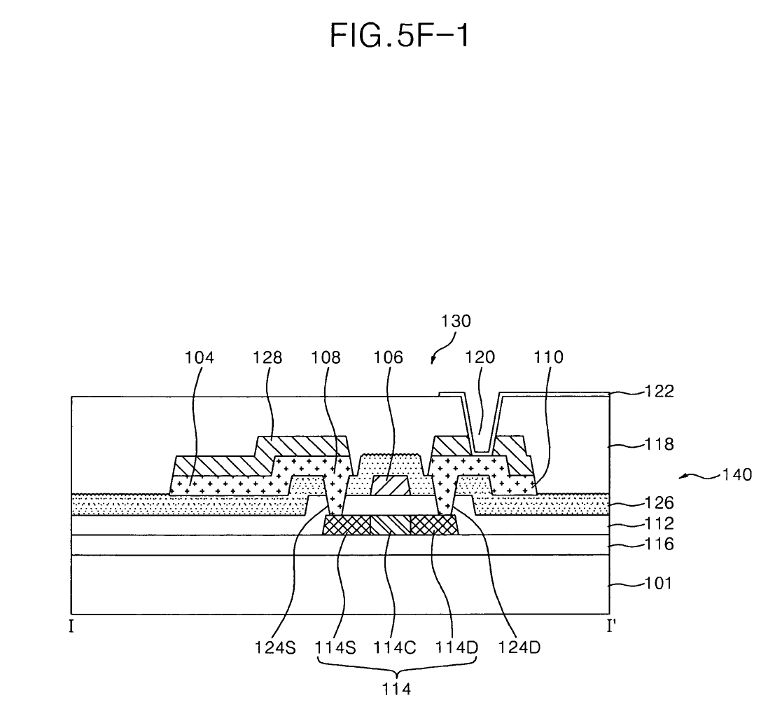

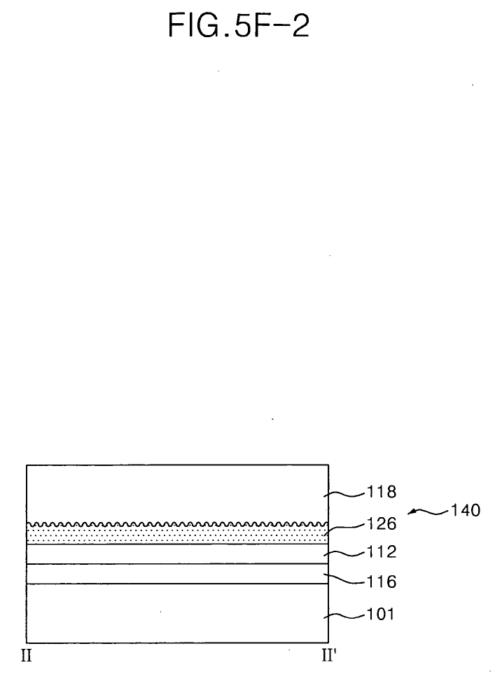

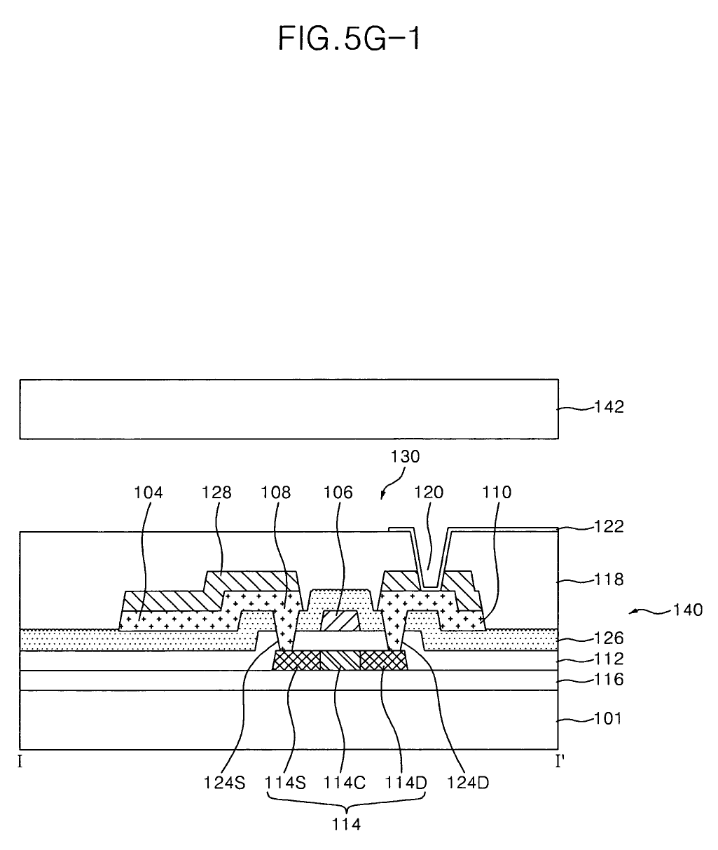

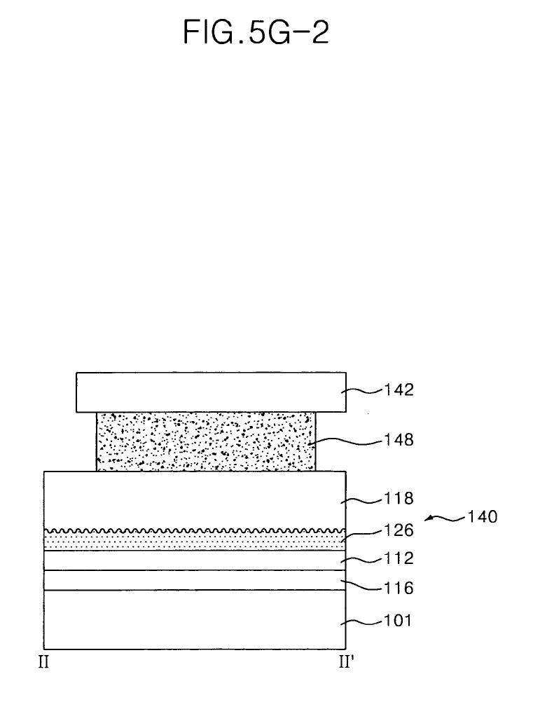

FIGS. 5A to 5G are cross-sectional views for explaining the process of fabricating an LCD panel according to an exemplary embodiment of the present invention. FIGS. 5A-1, 5B-1, 5C-1, 5D-1, 5E-1, 5F-1, and 5G-1 show cross sections along the line I-I′ shown in FIG. 2. FIGS. 5A-2, 5B-2, 5C-2, 5D-2, 5E-2, 5F-2, and 5G-2 show cross sections along the line II-II′ shown in FIG. 2.

Referring to FIG. 5A, the buffer layer 116 is formed on the lower substrate 101 and the active layer 114 is formed on the buffer layer 116.

Specifically, the buffer layer 116 is formed by depositing an inorganic insulating material such as SiO₂ on the lower substrate 101. To form the active layer 114, an amorphous silicon (“a-Si”) layer is deposited on the buffer 116 and crystallized by using a laser so as to be transformed into polysilicon. The polysilicon is then patterned using a photolithography process and an etching process.

Referring to FIG. 5B, the gate insulating layer 112 is formed on the buffer layer 116 on which the active layer 114 is formed, and a first conductive pattern group including the gate electrode 106 and the gate line 102 is formed on the gate insulating layer 112.

The gate insulating layer 112 is formed by depositing an inorganic insulating material such as SiO₂ on the buffer layer 116 on which the active layer 114 is formed. The first conductive pattern group including the gate electrode 106 and the gate line 102 is formed by forming a gate metal layer on the gate insulating layer 112 and then patterning the gate metal layer by using a photolithography process and an etching process. Thereafter, n+ impurities are injected into the active layer 114 by using the gate electrode 106 as a mask, thereby forming the source and drain regions 114S and 114D of the active layer 114 that is not covered by the gate electrode 106. The source region 114S is placed across a channel region 114 from the drain region 114D. The channel region 114C is disposed underneath the gate electrode 106.

Referring to FIG. 5C, the interlayer insulating layer 126 is formed on the gate insulating layer 112 on which the first conductive pattern group is formed, and the source and drain contact holes 124S and 124D penetrating the interlayer insulating layer 126 and gate insulating layer 112 are formed.

The interlayer insulating layer 126 is formed by depositing an inorganic insulating material such as SiNx or SiO₂ on the gate insulating layer 112 after the first conductive pattern group including the gate line 102 and the gate electrode 106 is formed. The source and drain contact holes 124S and 124D exposing parts of the source and drain regions 114S and 114D of the active layer 114 are formed by penetrating the interlayer insulating layer 126 and the gate insulating layer 112 by a photolithography process and an etching process.

Referring to FIG. 5D, a second conductive pattern group including the data line 104, the source electrode 108, and the drain electrode 110 is formed on the interlayer insulating layer 126. Then, the inorganic protective layer 128 is formed on the second conductive pattern.

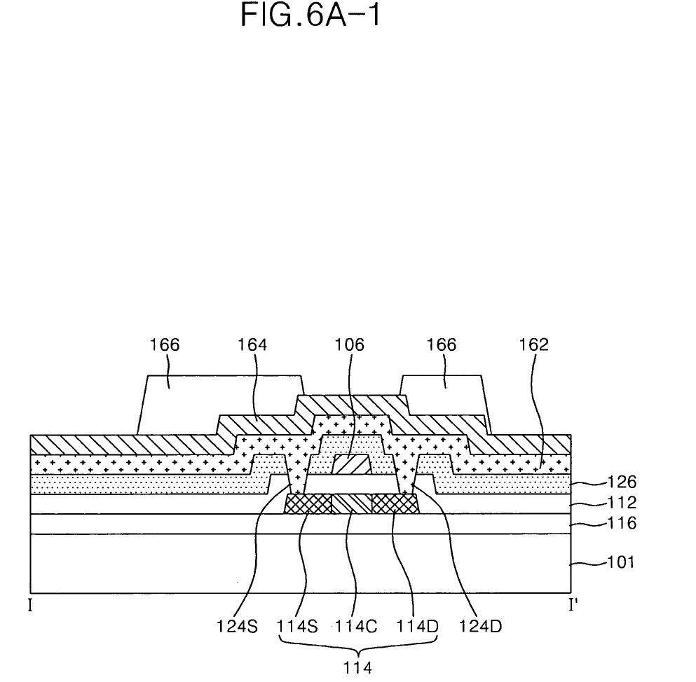

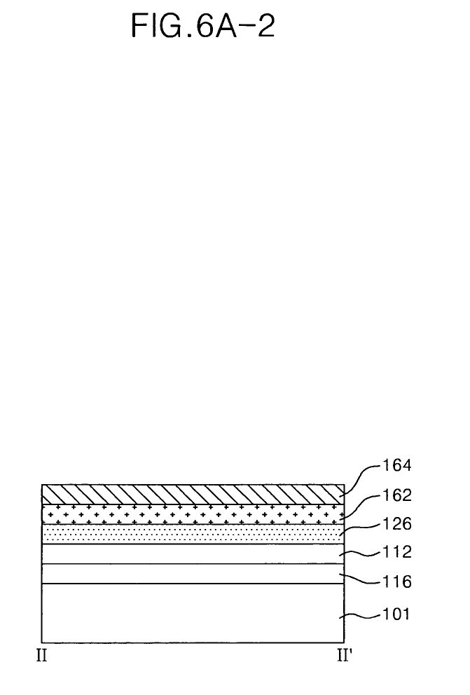

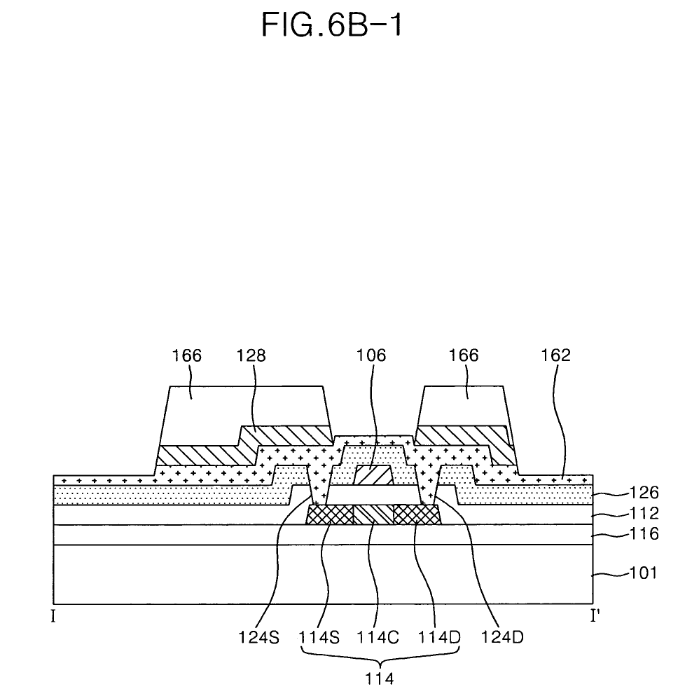

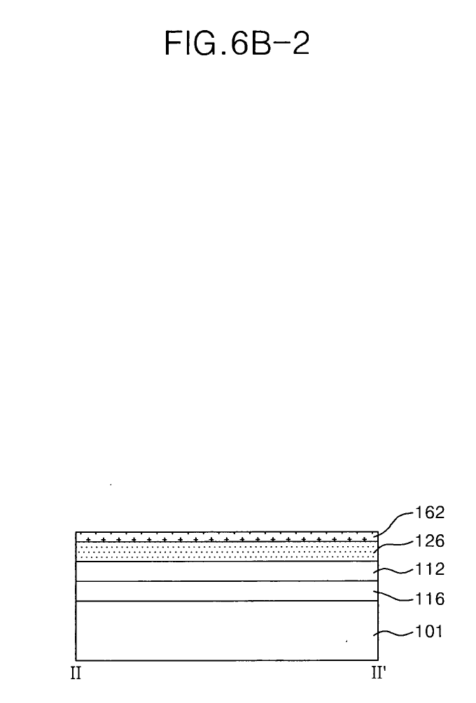

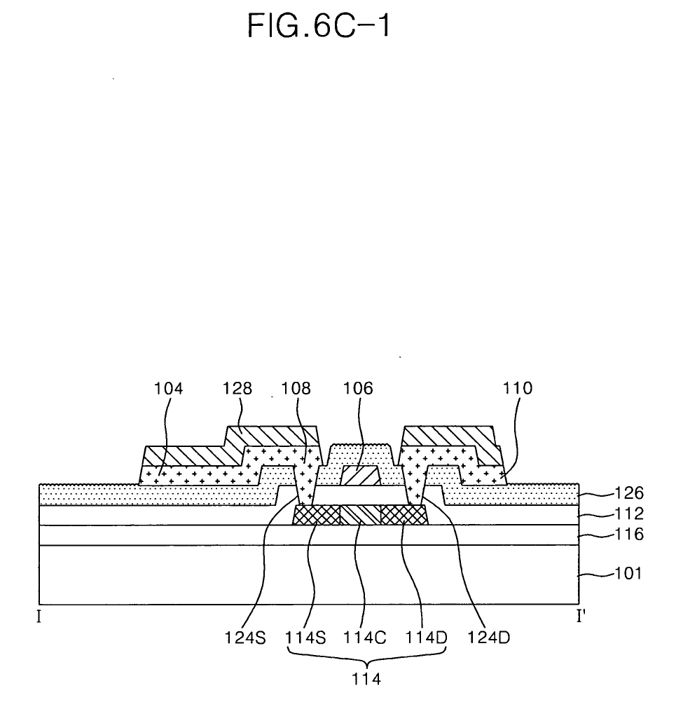

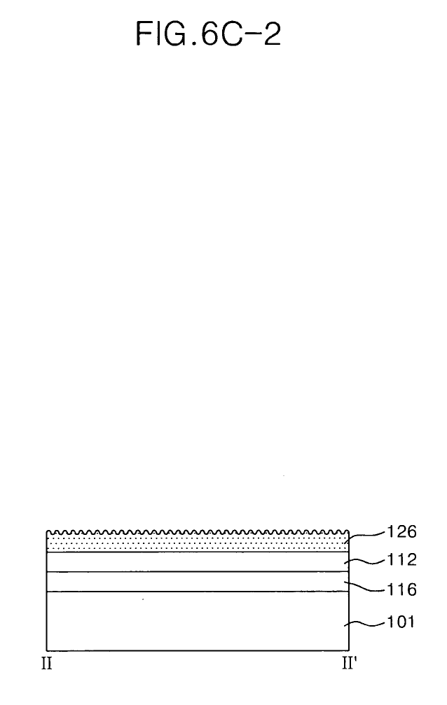

The process of fabricating the second conductive pattern group and the inorganic protective layer 128 will now be described in greater detail with reference to FIGS. 6A to 6C. FIGS. 6A-1, 6B-1, and 6C-1 show cross sections along the line I-I′ shown in FIG. 5D-1. FIGS. 6A-2, 6B-2, and 6C-2 show cross sections along the line II-II′ shown in FIG. 5D-2.

As illustrated in FIG. 6A, a data metal layer 162 and an inorganic insulating layer 164 are sequentially deposited on the interlayer insulating layer 126. The data metal layer 162 has a single layer structure and is composed of a metal, such as molybdenum (Mo), tungsten (W), aluminum (Al), copper (Cu) or molybdenum tungsten (MoW), or in a multilayered structure composed of a combination of these metals. An inorganic insulation material such as SiNx or SiOx is used as the inorganic insulating layer 164.

A photoresist is deposited on the inorganic insulating layer 164, and the photoresist is exposed and developed using a photomask, thereby forming a photoresist pattern 166. The inorganic insulating layer 164 and the data metal layer 162 are primarily etched through a dry etching process by using the photoresist pattern 166 as a mask. An etching gas such as SF₆, O₂, or SF₆+O₂ is used for the primary dry etching. By patterning the inorganic insulating layer 164, the inorganic protective layer 128 is formed on the data metal layer 162 as illustrated in FIG. 6B. A part of the data metal layer 162 is patterned along a photoresist pattern by reacting to the etching gas used when the inorganic protective layer 128 is patterned.

The data metal layer 162 is secondarily etched through a dry etching process by using the photoresist pattern 166 as a mask. An etching gas such as Cl₂, O₂, or Cl₂+O₂ is used for the secondary dry etching. Then the second conductive pattern group including the data line 104, the source electrode 108, and the drain electrode 110 is formed as illustrated in FIG. 6C. The interlayer insulating layer 126 has a concavo-convex pattern formed on its surface by being sputtered with the gas used during the secondary dry etching process. Accordingly, the surface area of the interlayer insulation layer 126 is increased and thus, the contact surface area with the organic protective layer 118 (which will be formed later) is increased.

Alternatively, a cleaning process utilizing a TMAH (Tetramethylammonium Hydroxide) solution may be used instead of the dry etching process to form the inorganic protective layer of the concavo-convex shape in contact with the organic protective layer. In this case, a cleaning process of about 10 minutes or more is necessary in order to make the surface of the inorganic protective layer a concavo-convex pattern after forming the inorganic protective layer. However, when using the dry etching process, an additional process is unnecessary because the surface of the interlayer insulating layer 126 is sputtered when the data metal layer 162 is patterned.

The size of the concave and convex region that is formed on the inorganic protective layer through the cleaning process is less than that of the interlayer insulating layer formed through the dry etching process. Therefore, the interlayer insulating layer 126 formed by using the dry etching process more effectively increases the bonding force to the organic protective layer 118 compared to the inorganic protective layer formed by using the cleaning process.

Referring to FIG. 5E, the organic protective layer 118 is formed on the interlayer insulating layer 126 on which the second conductive pattern group is formed, and the pixel contact hole 120 penetrating the inorganic protective layer 128 and organic protective layer 118 is formed.

The organic protective layer 118 is formed by depositing an organic insulating material such as photoacryl on the interlayer insulating layer 126 on which the data line 104 and the drain electrode 110 are formed. The pixel contact hole 120 penetrating the organic protective layer 118 and the inorganic protective layer 128 is formed by a photolithography process and an etching process. The pixel contact hole 120 exposes the drain electrode 110 of the TFT 130 by penetrating the inorganic protective layer 128 and the organic protective layer 118.

Referring to FIG. 5F, a third conductive pattern group including the pixel electrode 122 is formed on the organic protective layer 118.

The third conductive pattern group including the pixel electrode 122 is formed by depositing a transparent conductive layer such as indium-tin-oxide (ITO) on the organic protective layer 118 and then patterning the transparent conductive layer by a photolithography process and a dry etching process.

Referring to FIG. 5G, the TFT substrate 140 including the pixel electrode 122 is sealed to the separately prepared color filter substrate 142 by the sealant 148.

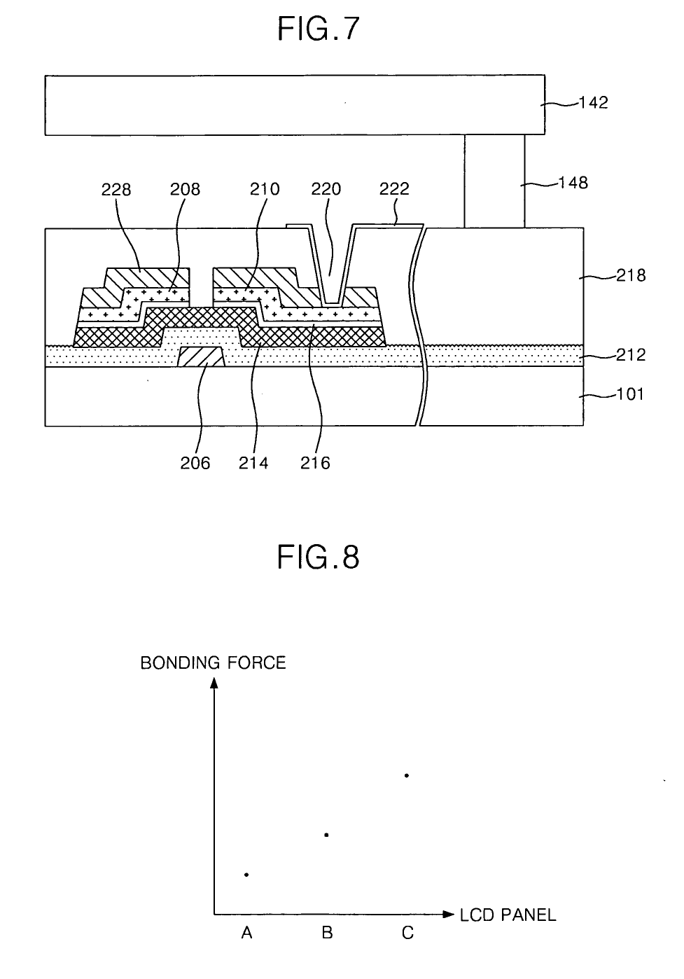

FIG. 7 is a cross-sectional view of a TFT substrate according to another exemplary embodiment of the present invention.

The TFT substrate shown in FIG. 7 includes the same elements as the TFT substrates shown in FIGS. 2 and 3 except that an a-Si TFT is used instead of a polysilicon TFT.

The a-Si TFT is formed on the substrate 101 and includes a gate electrode 206 connected to the gate line, a source electrode 208 connected to the data line, a drain electrode 210 connected to a pixel electrode 222, the active layer 214 forming a channel between the source and drain electrodes 208 and 210, and an ohmic contact layer 216 for an ohmic contact with the source and drain electrodes 208 and 210 and the active layer 214.

An inorganic protective layer 228 having essentially the same pattern as the source electrode 108, drain electrode 110 and data line 104 is formed thereon. The gate insulating layer 212 at a region overlapped by the inorganic protective layer 228 is formed to have a planarized surface. The gate insulating layer 212 in a region that is not covered by the inorganic protective layer 228 is patterned to have a concavo-convex surface. The height of at least one of the concave and convex pattern of the gate insulating layer 212 is about 100 to 1000 Å. The gate insulating layer 212 is made of an inorganic insulating material such as SiNx, which is the same material used for the inorganic protective layer 228.

In order to increase the aperture ratio, an organic protective layer 218 made of an organic insulating material such as photoacryl is formed on the lower substrate 101 on which the inorganic protective layer 228 is formed. The organic protective layer 218 is in contact with the gate insulating layer 22 of the concavo-convex pattern. Because the organic protective layer 218 is in contact with the gate insulating layer 212 of the concavo-convex pattern in a region where the sealant 148 is to be deposited, the bonding force between the organic protective layer 218 and the gate insulating layer 212 is improved. Accordingly, the concavo-convex pattern reduces the likelihood that the organic protective layer 218 and the gate insulating layer 212 will separate in a region where the sealant 148 is deposited.

As described above, the LCD panel of the exemplary embodiment of the present invention prevents separation between the layers in a region where the sealant 148 is deposited, by placing the gate insulating layer 212 having the concavo-convex pattern and the organic protective layer 218 in contact with each other.

Further, erosion of a driving circuit during the patterning process of the transparent conductive layer is prevented because the driving circuit formed on the lower substrate 101 is protected by the organic protective layer 218.

Furthermore, damage to the driving circuit is prevented because the organic protective layer 218 can endure the pressure applied on the TFT 130 through the sealant 148.

FIG. 8 is a view illustrating a bonding force of the layers of the LCD panel for the conventional LCD panel and the present invention. In FIG. 8, the abscissa denotes the LCD panels and the ordinate denotes the bonding force between the inorganic layer and organic layer. LCD panel A is a regular conventional LCD panel. LCD panel B is a conventional LCD panel with a larger sealant area than the panel A. LCD panel C is the panel of the invention. As illustrated in FIG. 8, the bonding force of the inventive LCD panel C is larger than that of the conventional LCD panel A. The bonding force of the inventive LCD panel C is also larger than that of an LCD panel B.

As can be appreciated from the foregoing description, the surface of at least one of the interlayer insulating layer and the gate insulating layer is processed by using an etching gas of the data metal layer. This way, the contact area between the inorganic insulating layer and the organic protective layer is increased and their separation is prevented.

While the invention has been shown and described with reference to a certain preferred embodiments, it will be understood by those skilled in the art that various changes in form and details may be made therein without departing from the spirit and scope of the invention as defined by the appended claims.

What is claimed is:

1. A thin film transistor substrate, comprising:
a thin film transistor connected to a gate line and a data line;
an organic protective layer for protecting the thin film transistor; and
an inorganic insulating layer formed between the gate line and the data line;
wherein the inorganic insulating layer is formed such that its contact surface with the organic protective layer has a different pattern from the rest of its surface.

2. The thin film transistor substrate of claim 1, further comprising an inorganic protective layer which is formed on the data line and source and drain electrodes of the thin film transistor and is patterned to have the same shape as the data line and the source and drain electrodes of the thin film transistor in plan view.

3. The thin film transistor substrate of claim 1, wherein the inorganic insulating layer is formed such that the contact surface with the organic protective layer has a concavo-convex pattern and the rest of its surface has a flat pattern.

4. A thin film transistor substrate sealed to a color filter substrate by a sealant, comprising:
a thin film transistor formed on a substrate and connected to a gate line and a data line;
an organic protective layer for protecting the thin film transistor; and
an inorganic insulating layer formed between the gate line and the data line;
wherein the inorganic insulating layer is formed such that its contact surface with the organic protective layer in a region overlapping the sealant has a concavo-convex pattern.

5. The thin film transistor substrate of claim 4, wherein a height of at least one of the bumps in the concavo-convex pattern of the inorganic insulating layer is about 100 to 1000 Å.

6. The thin film transistor substrate of claim 4, wherein the thin film transistor comprises:
an active layer formed on the substrate;
a gate electrode connected to the gate line on a gate insulating layer configured to cover the active layer;
a source electrode connected to the data line on an interlayer insulating layer configured to cover the gate electrode; and
a drain electrode formed on the interlayer insulating layer, the drain electrode positioned across the active layer from the source electrode.

7. The thin film transistor substrate of claim 6, wherein the inorganic insulating layer is the interlayer insulating layer formed such that its contact surface with the data line, source electrode and drain electrode is different from its contact surface with the organic protective layer.

8. The thin film transistor substrate of claim 7, wherein the interlayer insulating layer has a flat contact surface with the data line, source electrode and drain electrode.

9. The thin film transistor substrate of claim 6, further comprising an inorganic protective layer which is formed on the source electrode, drain electrode and data line and has the same shape as the source electrode, drain electrode and data line in plan view.

10. The thin film transistor substrate of claim 4, wherein the thin film transistor comprises:
a gate electrode formed on the substrate;
an amorphous silicon active layer formed on a gate insulating layer configured to cover the gate electrode;
an ohmic contact layer configured to expose a channel region of the active layer; and
source and drain electrodes positioned across the channel region from each other.

11. The thin film transistor substrate of claim 10, wherein the inorganic insulating layer is the gate insulating layer formed such that its contact surface with at least one of the active layer, ohmic contact layer, source electrode and drain electrode is different from its contact surface with the organic protective layer.

12. The thin film transistor substrate of claim 11, wherein the gate insulating layer has a flat contact surface with the data line, source electrode and drain electrode.

13. The thin film transistor substrate of claim 10, further comprising an inorganic protective layer which is formed on the source electrode, drain electrode and data line and has the same shape as the source electrode, drain electrode and data line in plan view.

14. A method of fabricating a thin film transistor substrate, comprising the steps of:
forming a first conductive pattern group including a gate electrode and a gate line on a substrate;
forming an inorganic insulating layer to cover the first conductive pattern group;
forming a second conductive pattern group including a data line, a source electrode and a drain electrode on the inorganic insulating layer and processing a surface of the inorganic insulating layer to have a contact surface with the second conductive pattern group different from a rest of its surface;
forming an organic protective layer to cover the second conductive pattern group; and
forming a third conductive pattern group including a pixel electrode on the organic protective layer.

15. The method of claim 14, wherein the forming of a second conductive pattern group and the processing of a surface of the inorganic insulating layer comprise forming an inorganic protective layer patterned to have the same shape as the second conductive pattern group on the second conductive pattern group.

16. The method of claim 15, wherein the forming of a second conductive pattern group and the processing of a surface of the inorganic insulating layer comprise:
sequentially depositing a data metal layer and the inorganic protective layer on the inorganic insulating layer;
forming a photoresist pattern on the inorganic protective layer;
primary-etching a part of the inorganic protective layer and the data metal layer by using the photoresist pattern; and
secondary-etching the data metal layer by using the photoresist pattern to form the second conductive pattern group and processing the surface of the inorganic insulating layer by using an etching gas used for the secondary etching.

17. The method of claim 16, wherein the etching gas used for the secondary etching is Cl₂, O₂, or Cl₂+O₂.

18. A liquid crystal display panel, comprising:
a thin film transistor substrate including an inorganic insulating layer having a patterned contact surface and a flat surface, the patterned contact surface having a concavo-convex pattern for interfacing with an organic protective layer that protects a thin film transistor;
a color filter substrate positioned substantially parallel to the thin film transistor substrate;
a liquid crystal disposed between the thin film transistor substrate and the color filter substrate; and
a sealant formed on a region overlapping the patterned contact surface, for sealing the thin film transistor substrate and the color filter substrate.

19. A method of fabricating a liquid crystal display panel, the method comprising:
preparing a color filter substrate;
preparing a thin film transistor substrate including an inorganic insulating layer having a patterned contact surface and a flat contact surface, the patterned contact surface having a concavo-convex pattern for interfacing with an organic protective layer that protects a thin film transistor; and
sealing the color filter substrate and the thin film transistor substrate by using a sealant formed on a region overlapping the inorganic insulating layer having the concavo-convex pattern.
